(19) United States
(12) Patent Application Publication
(10) Pub. No.: US 2024/0154960 A1
(43) Pub. Date: May 9, 2024

(54) TERMINAL DEVICE AND CLOUD COMPARISON METHOD

(71) Applicant: Egis Technology Inc., Hsinchu City (TW)

(72) Inventors: Qingsong Lin, Hsinchu City (TW); Yuan-Lin Chiang, Hsinchu City (TW)

(73) Assignee: Egis Technology Inc., Hsinchu City (TW)

(21) Appl. No.: 18/168,577

(22) Filed: Feb. 14, 2023

(30) Foreign Application Priority Data
Nov. 3, 2022 (CN) 202211368648.5

(51) Int. Cl. H04L 9/40; G06V 40/12; G06V 40/13; G06V 40/50

(52) U.S. Cl. CPC H04L 63/0861; G06V 40/13; G06V 40/1365; G06V 40/50

(57) ABSTRACT

The disclosure provides a terminal device and a cloud comparison method. The terminal device includes a storage device, a fingerprint sensor, and a fingerprint matching module. The storage device records a fingerprint template database, and the fingerprint sensor senses fingerprint data to be verified. The fingerprint matching module is coupled to the storage device and the fingerprint sensor, and compares the fingerprint data to be verified with the fingerprint template data in the fingerprint template database. In response to the fact that the fingerprint data to be verified does not match the fingerprint template data in the fingerprint template database, the terminal device uploads the fingerprint data to be verified to a server device via the network, and receives a verification result of the fingerprint data to be verified from the server device.

### CROSS-REFERENCE TO RELATED APPLICATION

This application claims the priority benefit of China application serial no. 202211368648.5 filed on Nov. 3, 2022. The entirety of the above-mentioned patent application is hereby incorporated by reference herein and made a part of this specification.

### BACKGROUND

### Technical Field

The disclosure relates to a fingerprint recognition technology, and in particular relates to a terminal device and a cloud comparison method.

### Description of Related Art

With the advancement of technology, fingerprint recognition has been widely used in the daily life of modern people. Based on various application scenarios of fingerprint recognition, various fingerprint recognition solutions are continuously developed. At present, the fingerprint recognition system may be roughly divided into a solution for performing fingerprint matching on a main processor of an electronic device and a solution for performing fingerprint matching on a fingerprint sensor chip (also known as match on chip, MOC). However, no matter in the solution of performing fingerprint matching on the main processor or the solution of performing fingerprint matching on the fingerprint sensor chip, the storage space for storing fingerprint template data is relatively limited. Especially, when the fingerprint recognition system needs to recognize a large number of fingerprints, it needs to store a large amount of fingerprint template data. Therefore, the storage space for storing fingerprint template data may be exhausted, and the additional fingerprint template data of other users or other fingers may not be stored, which also leads to relatively inflexible and limited practical application of the solution for performing fingerprint matching on a fingerprint sensor chip.

### SUMMARY

The disclosure relates to a terminal device and a cloud comparison method, which may be used to solve the aforementioned technical problems.

An embodiment of the disclosure provides a terminal device, which includes a storage device, a fingerprint sensor, and a fingerprint matching module. The storage device records a fingerprint template database, and the fingerprint sensor senses fingerprint data to be verified. The fingerprint matching module is coupled to the storage device and the fingerprint sensor, and compares the fingerprint data to be verified with the fingerprint template data in the fingerprint template database. In response to the fact that the fingerprint data to be verified does not match the fingerprint template data in the fingerprint template database, the terminal device uploads the fingerprint data to be verified to a server device via a network, and receives a verification result of the fingerprint data to be verified from the server device.

An embodiment of the disclosure provides a cloud comparison method, and the method includes the following operation. Fingerprint data to be verified is obtained via a fingerprint recognition device, in which the fingerprint recognition device includes a fingerprint template database. The fingerprint recognition device compares the fingerprint data to be verified with fingerprint template data in the fingerprint template database. In response to the fact that the fingerprint data to be verified does not match the fingerprint template data in the fingerprint template database, the fingerprint data to be verified is uploaded to a server device via a network. A verification result of the fingerprint data to be verified is received from the server device.

Based on the above, in the embodiment of the disclosure, when the fingerprint data to be verified does not match the fingerprint template data in the fingerprint template database, the terminal device may upload the fingerprint data to be verified to the server device. Therefore, the server device may compare the fingerprint data to be verified with the fingerprint template data in the fingerprint template database of the server device, and return the verification result to the terminal device. Based on this, since the server device may assist in verifying the qualification of the fingerprint data to be verified, not only the storage space of the fingerprint template database may be saved, but also the application flexibility of the fingerprint recognition device may be greatly improved.

### BRIEF DESCRIPTION OF THE DRAWING

FIG. 1 is a schematic diagram of a fingerprint recognition system according to an embodiment of the disclosure.

FIG. 2 is a schematic diagram of a terminal device according to an embodiment of the disclosure.

FIG. 3 is a flowchart of a cloud comparison method according to an embodiment of the disclosure.

FIG. 4 is a schematic diagram of a terminal device and a server device according to an embodiment of the disclosure.

FIG. 5 is a schematic diagram of a fingerprint registration procedure according to an embodiment of the disclosure.

FIG. 6 is a schematic diagram of a fingerprint recognition device generating a comparison successful result according to an embodiment of the disclosure.

FIG. 7 is a schematic diagram of a fingerprint recognition device generating a comparison failed result according to an embodiment of the disclosure.

### DETAILED DESCRIPTION OF DISCLOSED EMBODIMENTS

References of the exemplary embodiments of the disclosure are to be made in detail. Examples of the exemplary embodiments are illustrated in the drawings. If applicable, the same reference numerals in the drawings and the descriptions indicate the same or similar parts.

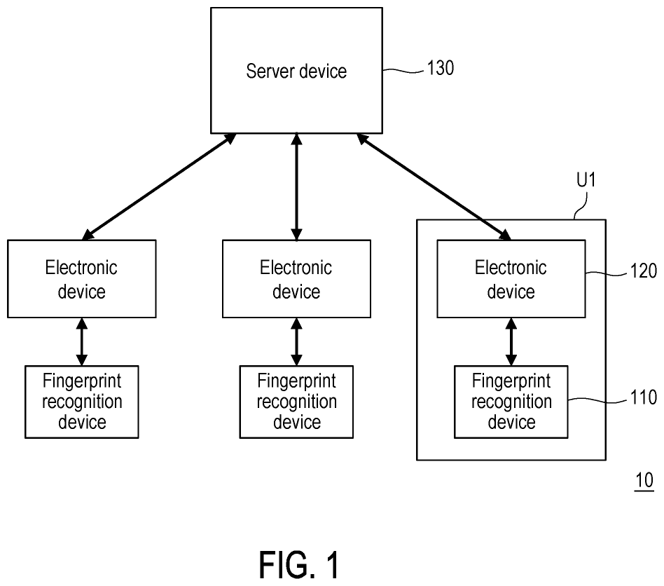

FIG. 1 is a schematic diagram of a fingerprint recognition system according to an embodiment of the disclosure. As shown in FIG. 1, a fingerprint recognition system 10 may include at least one terminal device U1 and a server device 130. The terminal device U1 has a fingerprint recognition function. The terminal device U1 may include a fingerprint recognition device 110 and an electronic device 120.

In some embodiments, the fingerprint recognition device 110 is a chip matching sensor, and the chip matching sensor is a system-on-a-chip integrated with a fingerprint sensing function and a fingerprint comparison function. In other embodiments, the fingerprint recognition device 110 may be formed by multiple chips having different functions.

The electronic device 120 has a networking function, and may be connected to the server device 130 via a wired network or a wireless network. The wired network includes, but are not limited to, a direct cable connection, Ethernet, etc. The wireless network is, for example, 4G/5G and other mobile communication networks (cellular networks), WiFi, Zigbee, and other wireless local area networks, but not limited thereto.

In some embodiments, the fingerprint recognition device 110 and the electronic device 120 may be integrated on a substrate. For example, the fingerprint recognition device 110 and the electronic device 120 may be integrated into a single electronic device, such as a mobile phone, a tablet computer, a notebook computer, a smart TV, an Internet of Things (IoT) device, etc. In some other embodiments, the fingerprint recognition device 110 may be coupled to the electronic device 120 through a transmission line. For example, the fingerprint recognition device 110 may be a fingerprint reader, and the electronic device 120 may be an access control system device having a network connection function. The fingerprint recognition device 110 may be connected to the electronic device 120 via a data transmission interface, such as a universal serial bus (USB) interface or an SPI interface.

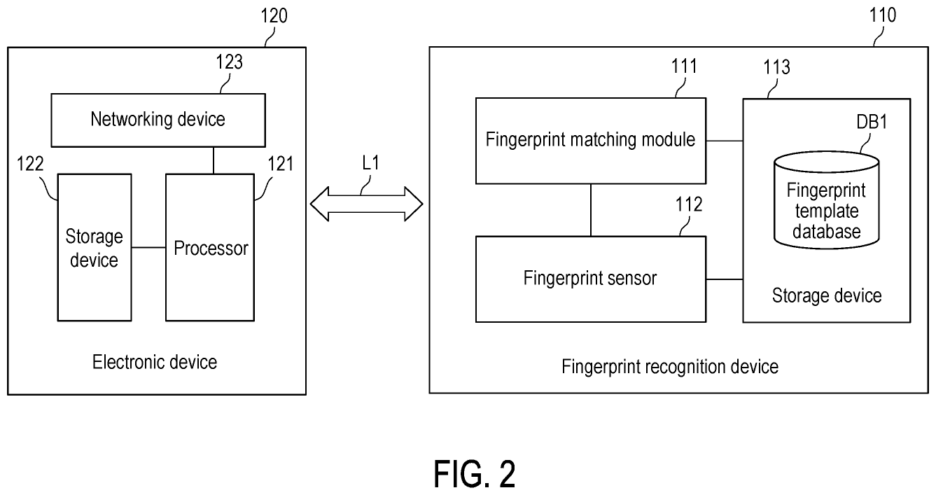

FIG. 2 is a schematic diagram of a terminal device according to an embodiment of the disclosure. As shown in FIG. 2, the fingerprint recognition device 110 includes a fingerprint matching module 111, a fingerprint sensor 112, and a storage device 113. The fingerprint matching module 111 is coupled to the fingerprint sensor 112 and the storage device 113. The fingerprint template database DB1 is recorded in the storage device 113, and the storage device 113 is, for example, a flash memory or other types of memory. The fingerprint matching module 111 may be realized by hardware, software, or a combination thereof. For example, the fingerprint matching module 111 is a microprocessor, but not limited thereto. The fingerprint sensor 112 may include an optical fingerprint sensor or a capacitive fingerprint sensor, etc. In some embodiments, when the fingerprint recognition device 110 is a chip matching sensor, the fingerprint matching module 111, the fingerprint sensor 112, and the storage device 113 are integrated into a system-on-a-chip. The fingerprint template database DB1 is recorded in the memory element in the system-on-a-chip. In some other embodiments, when the fingerprint recognition device 110 is formed multiple chips with different functions, the fingerprint matching module 111, the fingerprint sensor 112, and the storage device 113 may respectively be different chips. That is, the storage device 113 of the fingerprint recognition device 110 is a memory chip, the fingerprint matching module 111 may be the main processor of the terminal device U1, and the fingerprint template database DB1 is recorded in the memory chip of the terminal device U1.

On the other hand, the electronic device 120 includes a processor 121, a storage device 122, and a networking device 133. The processor 121 may execute the software modules, instructions or program codes in the storage device 122 to realize various operations of the electronic device 120 in various embodiments of the disclosure. In some embodiments, the processor 121 of the electronic device 120 may execute a software development kit (SDK) stored in the storage device 122. The networking device 133 may be connected to a wired network or a wireless network, such as a network card or a communication chip, etc.

In addition, the fingerprint recognition device 110 may communicate with the electronic device 120 via a data transmission interface L1. That is to say, the fingerprint recognition device 110 includes an input-output interface circuit (not shown) supporting the data transmission interface L1, and the electronic device 120 includes an input-output interface circuit (not shown) supporting the data transmission interface L1.

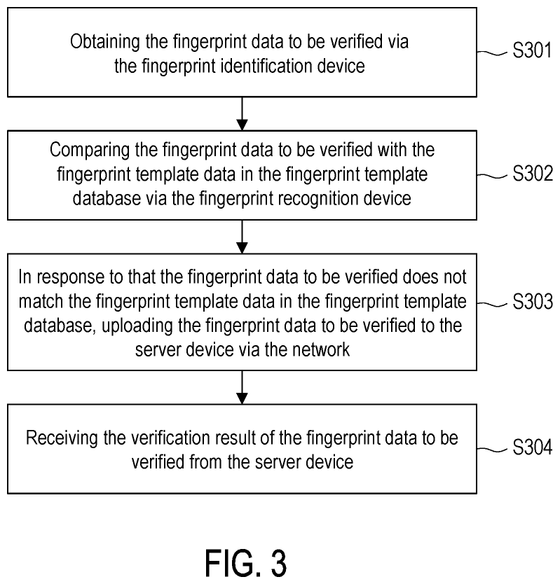

FIG. 3 is a flowchart of a cloud comparison method according to an embodiment of the disclosure. Referring to FIG. 3, the method of this embodiment is suitable for to the terminal device U1 in the aforementioned embodiment, and the details of each step in FIG. 3 is described below in conjunction with various elements in the terminal device U1.

In step S301, the fingerprint data to be verified is obtained via the fingerprint recognition device 110. Specifically, the fingerprint sensor 112 senses the fingerprint data to be verified, so that the fingerprint matching module 111 obtains the fingerprint data to be verified.

In step S302, the fingerprint data to be verified is compared with the fingerprint template data in the fingerprint template database DB1 via the fingerprint recognition device 110. Specifically, the fingerprint template database DB1 may record fingerprint template data of multiple registered fingerprints, and the fingerprint matching module 111 compares the fingerprint data to be verified with the fingerprint template data in the fingerprint template database DB1. It should be noted that the maximum amount of data stored in the fingerprint template database DB1 is limited by the hardware of the storage device 113. For example, the fingerprint template database DB1 may record fingerprint template data of 10 registered fingerprints from 10 different people at least.

In step S303, in response to the fact that the fingerprint data to be verified does not match the fingerprint template data in the fingerprint template database DB1, the terminal device U1 uploads the fingerprint data to be verified to the server device 130 via the network. In some embodiments, the fingerprint data to be verified and the comparison failed result are transmitted to the electronic device 120 via the fingerprint recognition device 110. That is to say, when the fingerprint matching module 111 determines that the comparison of the fingerprint data to be verified fails, the fingerprint recognition device 110 transmits the fingerprint data to be verified and the comparison failed result to the electronic device 120 via the data transmission interface L1. Afterwards, the fingerprint data to be verified is uploaded to the server device 130 via the network by the electronic device 120. That is, in response to receiving the comparison failed result, the electronic device 120 uploads the fingerprint data to be verified to the server device 130 via the network. The server device 130 also verifies the fingerprint data to be verified.

Then, in step S304, the terminal device U1 receives the verification result of the fingerprint data to be verified from the server device 130. In some embodiments, the verification result of the fingerprint data to be verified is received from the server device 130 via the electronic device 120. It may be seen that the server device 130 may assist the terminal device U1 to verify the qualification of the fingerprint data to be verified. Therefore, even if the fingerprint template database DB1 does not have fingerprint template data corresponding to the fingerprint data to be verified, the terminal device U1 may still obtain the comparison successful result of the fingerprint data to be verified from the server device 130.

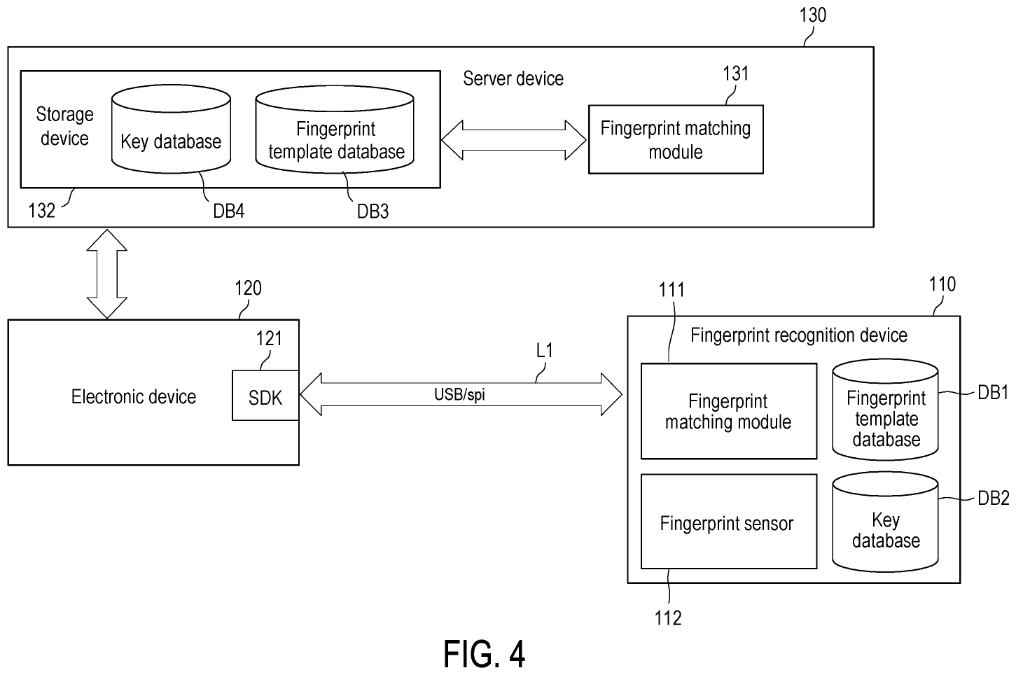

FIG. 4 is a schematic diagram of a terminal device and a server device according to an embodiment of the disclosure. Referring to FIG. 4, in addition to the fingerprint template database DB1, the storage device 113 of the fingerprint recognition device 110 further records a key database DB2. The server device 130 includes a fingerprint matching module 131 and a storage device 132. The storage device 132 of the server device 130 records a fingerprint template database DB3 and a key database DB4. The fingerprint matching module 131 may be realized by hardware, software, or a combination thereof. In addition, in this embodiment, the processor of the electronic device 120 may execute a software development kit (SDK) 121 to realize related operations in the cloud comparison method. It should be noted that when the fingerprint recognition device 110 uses the key recorded in the key database DB2 as the data encryptor, the server device 130 may use the key recorded in the key database DB4 as the data decryptor. On the contrary, when the fingerprint recognition device 110 uses the key recorded in the key database DB2 as the data decryptor, the server device 130 may use the key recorded in the key database DB4 as the data encryptor.

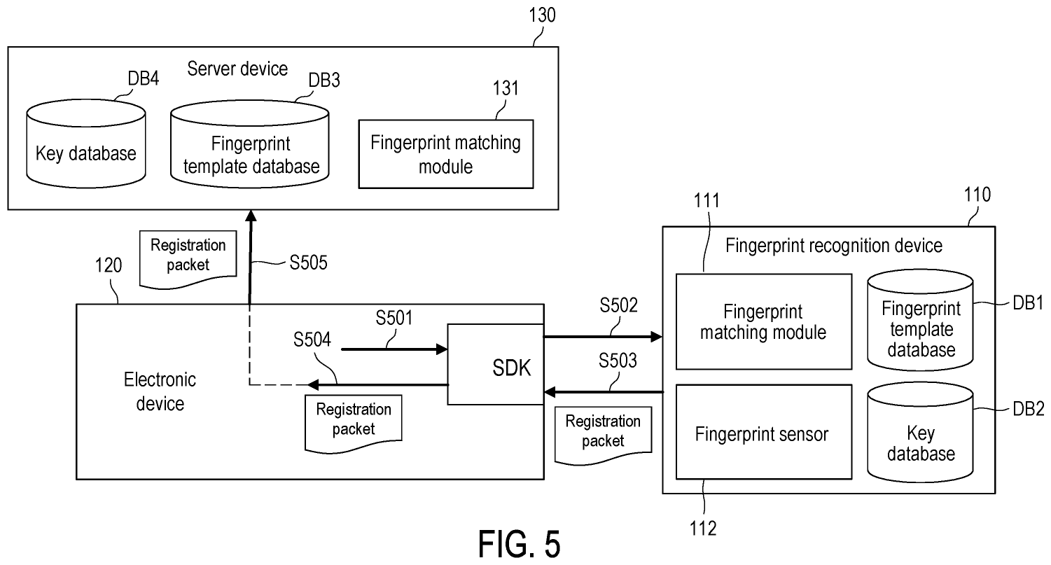

FIG. 5 is a schematic diagram of a fingerprint registration procedure according to an embodiment of the disclosure. Referring to FIG. 5, in step S501, the electronic device 120 initiates a fingerprint registration command, and the SDK 121 obtains the fingerprint registration command. In some embodiments, the fingerprint registration command may be initiated by an application program or an operating system operating on the electronic device 120. In step S502, the SDK 121 sends the fingerprint registration command to the fingerprint recognition device 110 via the data transmission interface L1. Afterwards, in response to the fingerprint registration command issued by the electronic device 120, the fingerprint sensor 112 may sense the registered fingerprint. That is to say, in response to the fingerprint registration command issued by the electronic device 120, the fingerprint recognition device 110 executes the fingerprint registration procedure to create fingerprint template data, and writes the fingerprint template data into the fingerprint template database DB1. Moreover, after the fingerprint recognition device 110 completes the fingerprint registration procedure, the fingerprint recognition device 110 may generate a registration packet including fingerprint template data.

In step S503, the fingerprint recognition device 110 returns the registration packet to the SDK 121. That is to say, the fingerprint recognition device 110 transmits the registration packet including the fingerprint template data to the electronic device 120. In step S504, the SDK 121 returns the registration packet to the electronic device 120. Afterwards, as shown in FIG. 5, in step S505, the electronic device 120 uploads the registration packet to the server device 130 via the network, so that the server device 130 may record the fingerprint template data in the registration packet into the fingerprint template database DB3. In addition, other information related to the fingerprint template data in the registration packet may also be recorded in the fingerprint template database DB3. It may be seen that when the user performs the fingerprint registration procedure through the fingerprint recognition device 110, the fingerprint template data of the registered fingerprint may be synchronously recorded in the fingerprint template database DB3 of the server device 130. It is worth mentioning that the fingerprint template database DB3 of the server device 130 may record registration packets from multiple different terminal devices.

In some embodiments, the registration packet may include template unique identifier (template UID), fingerprint template data, template created time, template invalid time, template use times, template use limited times, and other information about registered fingerprints.

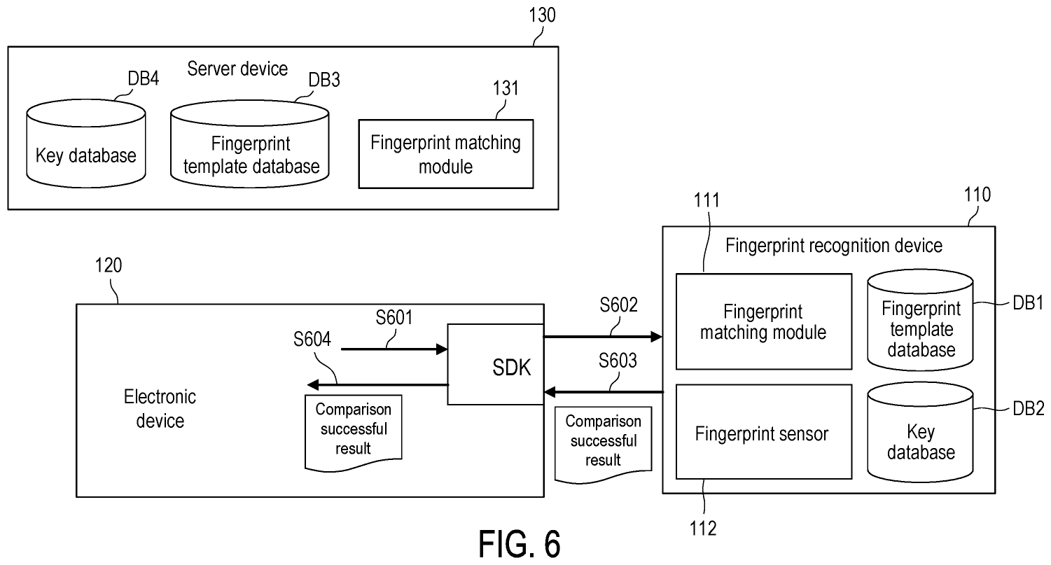

FIG. 6 is a schematic diagram of a fingerprint recognition device generating a comparison successful result according to an embodiment of the disclosure. Referring to FIG. 6, in step S601, the electronic device 120 initiates a fingerprint comparison command, and the SDK 121 obtains a fingerprint registration command. In some embodiments, the fingerprint comparison command may be issued by an application program or an operating system operating on the electronic device 120. In step S602, the SDK 121 sends the fingerprint comparison command to the fingerprint recognition device 110 via the data transmission interface L1. Therefore, in response to receiving the fingerprint comparison command, the fingerprint recognition device 110 obtains the fingerprint data to be verified through the fingerprint sensor 112, and compares the fingerprint data to be verified with the fingerprint template data in the fingerprint template database DB1 through the fingerprint matching module 111. In step S603, in response to the fact that the fingerprint data to be verified matches the fingerprint template data in the fingerprint template database DB1 (the comparison is successful), the fingerprint recognition device 110 returns a comparison successful result to the SDK 121. In step S604, the SDK 121 returns the comparison successful result to the electronic device 120, so that the electronic device 120 may perform subsequent operations according to the comparison successful result.

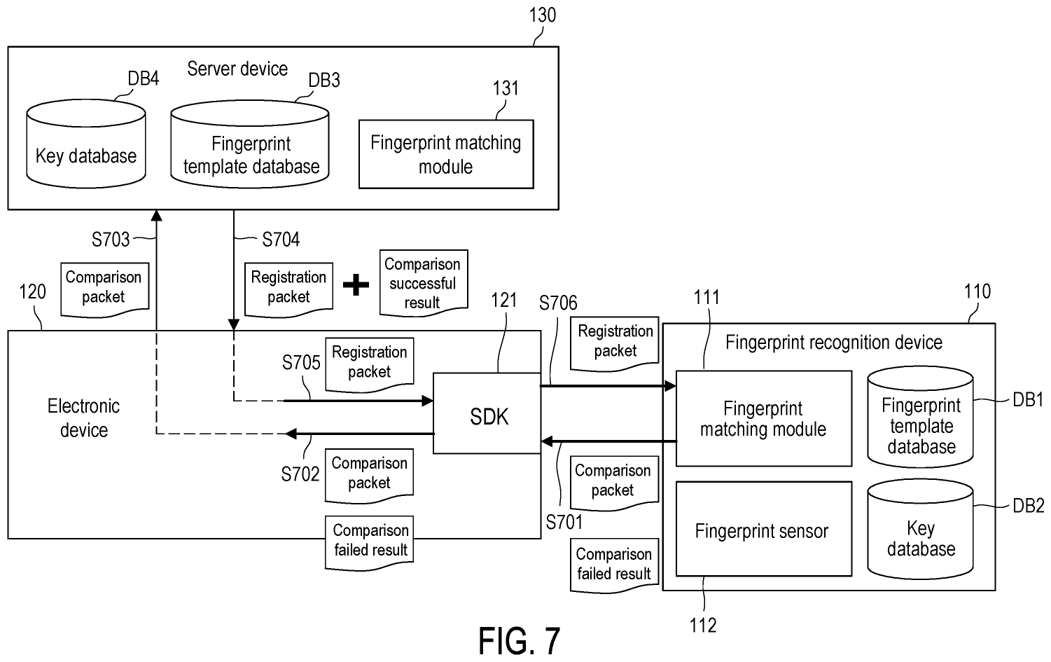

FIG. 7 is a schematic diagram of a fingerprint recognition device generating a comparison failed result according to an embodiment of the disclosure. Referring to FIG. 7, in step S701, the fingerprint recognition device 110 determines that the fingerprint data to be verified does not match the fingerprint template data in the fingerprint template database DB1 (the comparison fails), and returns a comparison failed result and the comparison packet including the fingerprint data to be verified to the SDK 121. That is to say, in response to the fact that the fingerprint data to be verified does not match the fingerprint template data in the fingerprint template database DB1, the fingerprint recognition device 110 sends the fingerprint data to be verified and the comparison failed result to the electronic device 120. In step S702, the SDK 121 returns the comparison failed result and the comparison packet to the electronic device 120. In step S703, in response to receiving the comparison failed result, the electronic device 120 uploads the comparison packet to the server device 130 via the network. That is to say, the electronic device 120 uploads the fingerprint data to be verified to the server device 130 via the network. Afterwards, in response to receiving the comparison packet, the server device 130 compares the fingerprint template data in the fingerprint template database DB3 with the fingerprint data to be verified in the comparison packet through the fingerprint matching module 131.

In step S704, in response to the fact that the fingerprint data to be verified matches the fingerprint template data in the template database DB3 (the comparison is successful), the server device 130 returns a comparison successful result and a registration packet including the fingerprint template data that is successfully compared to the electronic device 120. Wherein, the fingerprint data to be verified and the fingerprint template data in the registration packet correspond to the same fingerprint. In response to receiving a comparison successful result of the fingerprint data to be verified and the registration packet from the server device 130, the electronic device 120 transmits the registration packet to the fingerprint recognition device 110. Then, in step S705, in response to receiving the comparison successful result, the electronic device 120 transmits the registration packet provided by the server device 130 to the SDK 121. In step S706, the SDK 121 returns the registration packet to the fingerprint recognition device 110. Afterwards, the fingerprint recognition device 110 writes the fingerprint template data in the registration packet into the fingerprint template database DB1.

In some embodiments, when the fingerprint recognition device 110 and the electronic device 120 transmit the registration packet and the comparison packet, the fingerprint recognition device 110 may encrypt and decrypt the transmission data according to the key of the key database DB2. Correspondingly, when the server device 130 and the electronic device 120 transmit the registration packet and the comparison packet, the server device 130 may encrypt and decrypt the transmission data according to the key of the key database DB4.

More specifically, in some embodiments, the fingerprint recognition device 110 may use the key in the key database DB2 to encrypt the fingerprint data to be verified, and transmit the encrypted fingerprint data to be verified to the electronic device 120. Correspondingly, the electronic device 120 uploads the encrypted fingerprint data to be verified to the server device 130, and the server device 130 may decrypt the encrypted fingerprint data to be verified according to the key of the key database DB4. In addition, in some embodiments, after completing the fingerprint registration procedure, the fingerprint recognition device 110 encrypts the fingerprint template data with the key in the key database DB2, and transmits the encrypted fingerprint template data to the electronic device 120. Correspondingly, the electronic device 120 uploads the encrypted fingerprint template data to the server device 130, and the server device 130 decrypts the encrypted fingerprint template data according to the key of the key database DB4. In this way, exposure of the fingerprint template data or the fingerprint data to be verified during transmission may be avoided, and malicious software attacks on the electronic device 120 may also be resisted.

In some embodiments, the fingerprint recognition device 110 may delete the fingerprint template data in the fingerprint template database DB1 according to the usage status of the fingerprint template data. In detail, since the storage space of the fingerprint template database DB1 of the fingerprint recognition device 110 is limited, the fingerprint recognition device 110 may manage the fingerprint template data in the fingerprint template database DB1, so as to delete some fingerprint template data in a timely manner. That is to say, the fingerprint recognition device 110 may delete the fingerprint template data in the fingerprint template database DB1 that meets the specific deletion condition, so that new fingerprint template data may be stored in the fingerprint template database DB1. Therefore, when the fingerprint recognition device 110 receives the registration packet generated by the server device 130, the fingerprint template database DB1 has enough storage space to record the fingerprint template data in the registration packet. In this way, the fingerprint template data in the fingerprint template database DB1 may be updated in a timely manner with the help of the server device 130, so that the application of the fingerprint recognition device 110 may be more flexible and unlimited. In addition, it is more ensured that the storage space of the fingerprint template database DB1 of the fingerprint recognition device 110 may record the fingerprint template data that the user really needs.

In some embodiments, in response to the storage status of the fingerprint template database DB1 meeting a specific condition, the fingerprint recognition device 110 deletes the fingerprint template data with the lowest comparison successful times in the fingerprint template database. That is to say, the fingerprint recognition device 110 may accumulate the comparison successful times of the fingerprint template data of each registered fingerprint, and record the comparison successful times of the fingerprint template data of each registered fingerprint in the fingerprint template database DB1. When the fingerprint recognition device 110 is to write new fingerprint template data but the storage space of the fingerprint template database DB1 is insufficient, the fingerprint recognition device 110 may compare the comparison successful times of all the fingerprint template data in the fingerprint template database DB1, and delete the fingerprint template data with the lowest comparison successful times in the fingerprint template database DB1.

In some embodiments, the aforementioned specific condition may include that the amount of fingerprint template data recorded in the fingerprint template database DB1 is greater than or equal to a preset value. For example, when the fingerprint template database DB1 has recorded fingerprint template data of 10 registered fingerprints, the fingerprint recognition device 110 may determine that the storage status of the fingerprint template database DB1 meets the specific condition. Alternatively, in some embodiments, the specific condition may include that the available storage space of the fingerprint template database DB1 is less than a threshold value. For example, when the available storage space of the fingerprint template database DB1 is less than M KB, the fingerprint recognition device 110 may determine that the storage status of the fingerprint template database DB1 meets the specific condition.

In some embodiments, the fingerprint recognition device 110 calculates the cumulative time length between the template created time of the fingerprint template data and the current time. In response to the fact that the cumulative time length meets the template invalid time, the fingerprint recognition device 110 deletes the fingerprint template data in the fingerprint template database DB1. Specifically, when the cumulative time length between the template created time and the current time of a certain fingerprint template data in the fingerprint template database DB1 is equal to the template invalid time (e.g., 7 days), the fingerprint template data may be deleted from the fingerprint template database DB1.

In some embodiments, the fingerprint recognition device 110 determines whether the comparison successful times of the fingerprint template data is equal to the template use limited times. In response to the fact that the comparison successful times of the fingerprint template data is equal to the template use limited times, the fingerprint recognition device 110 deletes the fingerprint template data in the fingerprint template database DB1. Specifically, when the comparison successful times of a piece of fingerprint template data in the fingerprint template database DB1 is equal to the template use limited times (e.g., 5 times), the fingerprint template data may be deleted from the fingerprint template database DB1.

To sum up, in the embodiment of the disclosure, the fingerprint recognition device may upload the fingerprint data to be verified to the server device through the electronic device for verification and comparison. Based on this, since the server device may assist in verifying the qualification of the fingerprint data to be verified, the storage space of the fingerprint template database in the fingerprint recognition device may be saved. In addition, the fingerprint recognition device may write the fingerprint template data provided by the server device into the fingerprint template database of the fingerprint recognition device, and the fingerprint recognition device may delete the fingerprint template data in the fingerprint template database according to the usage status of the fingerprint template data. Based on this, under the condition that the storage space of the fingerprint template database is limited, the fingerprint template database of the fingerprint recognition device may be dynamically updated through the server device and may meet various application requirements.

Finally, it should be noted that the foregoing embodiments are only used to illustrate the technical solutions of the disclosure, but not to limit the disclosure; although the disclosure has been described in detail with reference to the foregoing embodiments, persons of ordinary skill in the art should understand that the technical solutions described in the foregoing embodiments may still be modified, or parts or all of the technical features thereof may be equivalently replaced; however, these modifications or substitutions do not deviate the essence of the corresponding technical solutions from the scope of the technical solutions of the embodiments of the disclosure.

What is claimed is:

1. A terminal device, comprising:
a storage device, recording a fingerprint template database;
a fingerprint sensor, sensing fingerprint data to be verified; and
a fingerprint matching module, coupled to the storage device and the fingerprint sensor, comparing the fingerprint data to be verified with fingerprint template data in the fingerprint template database,
in response to the fact that the fingerprint data to be verified does not match the fingerprint template data in the fingerprint template database, the terminal device uploading the fingerprint data to be verified to a server device via a network and receiving a verification result of the fingerprint data to be verified from the server device.

2. The terminal device according to claim 1, wherein the terminal device comprises an electronic device and a fingerprint recognition device, and the fingerprint recognition device comprises the storage device, the fingerprint sensor, and the fingerprint matching module,
in response to the fact that the fingerprint data to be verified does not match the fingerprint template data in the fingerprint template database, the fingerprint recognition device sends the fingerprint data to be verified and a comparison failed result to the electronic device, the electronic device uploads the fingerprint data to be verified to the server device via the network.

3. The terminal device according to claim 2, wherein in response to receiving a comparison successful result of the fingerprint data to be verified and a registration packet from the server device, the electronic device transmits the registration packet to the fingerprint recognition device, and the fingerprint recognition device writes another fingerprint template data in the registration packet into the fingerprint template database.

4. The terminal device according to claim 3, wherein the fingerprint data to be verified corresponds to same fingerprint as the another fingerprint template data in the registration packet.

5. The terminal device according to claim 2, wherein in response to a fingerprint registration command issued by the electronic device, the fingerprint sensor obtains the fingerprint template data, the fingerprint recognition device writes the fingerprint template data into the fingerprint template database and sends a registration packet comprising the fingerprint template data to the electronic device.

6. The terminal device according to claim 5, wherein the electronic device uploads the registration packet to the server device via the network, so that the fingerprint template data in the registration packet is recorded in another fingerprint template database of the server device.

7. The terminal device according to claim 2, wherein the fingerprint recognition device deletes the fingerprint template data in the fingerprint template database according to a usage status of the fingerprint template data.

8. The terminal device according to claim 7, wherein in response to the fact that a storage status of the fingerprint template database meets a specific condition, the fingerprint recognition device deletes the fingerprint template data with lowest comparison successful times in the fingerprint template database.

9. The terminal device according to claim 7, wherein the fingerprint recognition device calculates a cumulative time length between template created time of the fingerprint template data and current time, in response to the fact that the cumulative time length meets a template invalid time, the fingerprint recognition device deletes the fingerprint template data in the fingerprint template database.

10. The terminal device according to claim 7, wherein the fingerprint recognition device determines whether comparison successful times of the fingerprint template data is equal to template use limited times, in response to the fact that the comparison successful times of the fingerprint template data is equal to the template use limited times, the fingerprint recognition device deletes the fingerprint template data in the fingerprint template database.

11. The terminal device according to claim 2, wherein the fingerprint recognition device and the electronic device are integrated on a substrate.

12. The terminal device according to claim 2, wherein the fingerprint recognition device is coupled to the electronic device.

13. The terminal device according to claim 2, wherein the fingerprint recognition device is a chip matching sensor.

14. The terminal device according to claim 2, wherein the storage device of the fingerprint recognition device is a memory chip.

15. A cloud comparison method, comprising:
obtaining fingerprint data to be verified via a fingerprint recognition device, wherein the fingerprint recognition device comprises a fingerprint template database;
comparing the fingerprint data to be verified with fingerprint template data in the fingerprint template database via the fingerprint recognition device;
in response to the fact that the fingerprint data to be verified does not match the fingerprint template data in the fingerprint template database, uploading the fingerprint data to be verified to a server device via a network; and
receiving a verification result of the fingerprint data to be verified from the server device.

16. The cloud comparison method according to claim 15, wherein in response to the fact that the fingerprint data to be verified does not match the fingerprint template data in the fingerprint template database, uploading the fingerprint data to be verified to the server device via the network comprises:
in response to the fact that the fingerprint data to be verified does not match the fingerprint template data in the fingerprint template database, sending the fingerprint data to be verified and a comparison failed result to the electronic device via the fingerprint recognition device, uploading the fingerprint data to be verified to the server device via the network by the electronic device.

17. The cloud comparison method according to claim 16, further comprising:
in response to receiving a comparison successful result of the fingerprint data to be verified and a registration packet from the server device, transmitting the registration packet to the fingerprint recognition device via the electronic device; and
writing another fingerprint template data in the registration packet into the fingerprint template database via the fingerprint recognition device.

18. The cloud comparison method according to claim 17, wherein the fingerprint data to be verified corresponds to same fingerprint as the another fingerprint template data in the registration packet.

19. The cloud comparison method according to claim 16, wherein the server device comprises another fingerprint template database, the method further comprising:
comparing the fingerprint data to be verified with the fingerprint template data in the another fingerprint template database via the server device; and
in response to the fact that the fingerprint data to be verified matches the fingerprint template data in the another fingerprint template database, transmitting a comparison successful result of the fingerprint data to be verified and the registration packet to the electronic device via the server device.

20. The cloud comparison method according to claim 16, further comprising:
in response to a fingerprint registration command issued by the electronic device, obtaining the fingerprint template data via the fingerprint recognition device;
writing the fingerprint template data into the fingerprint template database via the fingerprint recognition device; and
sending a registration packet comprising the fingerprint template data to the electronic device via the fingerprint recognition device.

21. The cloud comparison method according to claim 20, further comprising:
uploading the registration packet to the server device via the network by the electronic device; and
recording the fingerprint template data in the registration packet in another fingerprint template database of the server device via the server device.

22. The cloud comparison method according to claim 16, further comprising:
deleting the fingerprint template data in the fingerprint template database via the fingerprint recognition device according to a usage status of the fingerprint template data.

23. The cloud comparison method according to claim 22, wherein deleting the fingerprint template data in the fingerprint template database via the fingerprint recognition device according to the usage status of the fingerprint template data comprises:
in response to the fact that a storage status of the fingerprint template database meets a specific condition, deleting the fingerprint template data with lowest comparison successful times in the fingerprint template database via the fingerprint recognition device.

24. The cloud comparison method according to claim 22, wherein deleting the fingerprint template data in the fingerprint template database via the fingerprint recognition device according to the usage status of the fingerprint template data comprises:
calculating a cumulative time length between template created time of the fingerprint template data and current time via the fingerprint recognition device; and
in response to the fact that the cumulative time length meets a template invalid time, deleting the fingerprint template data in the fingerprint template database via the fingerprint recognition device.

25. The cloud comparison method according to claim 22, wherein deleting the fingerprint template data in the fingerprint template database via the fingerprint recognition device according to the usage status of the fingerprint template data comprises:
determining whether comparison successful times of the fingerprint template data is equal to template use limited times via the fingerprint recognition device; and
in response to the fact that the comparison successful times of the fingerprint template data is equal to the template use limited times, deleting the fingerprint template data in the fingerprint template database via the fingerprint recognition device.
